(19) United States
(12) Patent Application Publication
(10) Pub. No.: US 2010/0288226 A1
(43) Pub. Date: Nov. 18, 2010

(54) High efficiency reciprocating internal combustion engine

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 12/583,508

(22) Filed: Aug. 20, 2009

Related U.S. Application Data
(60) Provisional application No. 61/216,172, filed on May 14, 2009.

(51) Int. Cl. F02B 17/00; F02M 7/00

(52) U.S. Cl. 123/295; 123/436

(57) ABSTRACT

A method is provided for operating a lean-burn homogeneous charge reciprocating internal combustion engine that includes providing an unthrottled fuel-air compression charge having a lean fuel-air ratio, passing the fuel-air compression charge to fill no more than sixty percent of a cylinder within the internal combustion engine, compressing the fuel-air compression charge within the cylinder, igniting the compressed fuel-air compression charge for combustion, and passing exhaust resulting from the combustion to a NOx removal system. A non-platinum oxidation catalyst may be used to control carbon monoxide emissions in the exhaust Engine power may be varied by controlling the engine speed with a continuously variable transmission, by varying the applied engine load to charge a hybrid system battery, or by varying the amount of the lean fuel-air mixture charged.

### CROSS-REFERENCE

This application claims the benefit of U.S. Provisional Application No. 61/216,172 filed on May 14, 2009.

### BACKGROUND OF THE INVENTION

1. Field of the Invention

This invention relates to an improved method of operating homogeneous charge internal combustion engines. More specifically, this invention relates to a method and means for achieving maximum thermal efficiency from homogeneous charge, lean-burn reciprocating internal combustion engines.

2. Brief Description of the Related Art

The homogeneous charge reciprocating internal combustion engine represents the present state of the art for gasoline-powered engines that generally comprises the mixing of fuel and air together and subsequently vaporizing the mixture prior to combustion. In contrast, the operation of a diesel engine generally comprises depositing droplets of fuel into the air which combination is then combusted. The present invention provides an improved method for operating a homogeneous charge reciprocating engine and compares such improvement to the operation of a diesel engine.

Unthrottled, lean fuel-air ratio internal combustion engines, such as the diesel engine or a spark-ignited lean-burn engine, can achieve a significantly higher thermal efficiency than the throttled stoichiometric combustion engines used in most automobiles. In diesel engines, power is determined by the amount of fuel injected into compressed air. Thus, combustion in a diesel engine is essentially stoichiometric at the fuel droplet-air interface resulting in high local temperatures in the surrounding air and soot by pyrolysis of fuel in the fuel droplet. The result is high emissions of NOx and soot but high thermal efficiency. Because fuel is injected into compressed air, compression ratio is not limited.

In Otto cycle engines, lean homogeneous combustion imposes flame stability limitations which to date have limited the capability to achieve lean enough operation for acceptable NOx levels, particularly at high engine speeds. Thus, to allow NOx control, conventional spark-ignited Otto cycle engines operate with stoichiometric fuel-air ratios with air flow throttled to adjust power level. In the absence of excess oxygen, three-way exhaust catalysts allow low emissions of NOx, hydrocarbons and carbon monoxide. One problem associated with this prior art is that the use of platinum-containing catalysts permits the emission of platinum oxides into the air. Throttling, together with insufficient oxygen for complete combustion, will result in a lower efficiency than a diesel engine. In addition, because fuel is present during compression, the maximum compression ratio is limited by pre-ignition during the compression stroke. Thus, the compression ratio is much lower in comparison to diesel engines lowering potential efficiency.

As a result, conventional spark-ignited Otto cycle engines are less efficient than diesel engines in spite of operating in close approximation to the more efficient constant volume combustion Otto cycle. Thus, there is much effort to develop lean NOx control systems to allow use of lean-burn gasoline engines. However, throttling is still used. An attractive alternative to throttling is inlet valve control of the amount of the charged fuel-air mixture.

It is therefore an object of the present invention to provide a method for the operation of an internal combustion engine/electric motor drive system whereby the internal combustion engine fuel-air charge quantity and the adiabatic flame temperature may be controlled to maximize the efficiency of the overall system. It is another object of the present invention to provide a method and means for achieving low NOx operation of homogeneous charge, lean-burn reciprocating internal combustion engines. It is yet another object of the present invention to provide a method for the unthrottled operation of a conventional spark-ignited Otto cycle engine sufficiently lean to maximize thermal efficiency.

### SUMMARY OF THE INVENTION

It has now been found that a homogeneous charge internal combustion engine, such as a reciprocating engine utilizing conventional gasoline fuel or any suitable substitute, may be operated unthrottled and sufficiently lean to achieve high thermal efficiency and low pollutant emissions. NOx may be controlled by use of a NOx trap such as has been developed for diesel engines. NOx levels as low as 1 to 10 ppm are feasible. Moreover, even with lean combustion, the emission of platinum oxides from conventional clean-up catalysts can also be eliminated. With lean operation, emission of hydrocarbons and carbon monoxide is greatly reduced. Emissions may be further reduced by using an ultra low volatility non-platinum oxidation catalyst such as palladium, for example, to control carbon monoxide emissions in the exhaust.

By operation in an internal combustion engine/electric motor drive system, the internal combustion engine fuel-air charge amount may be controlled such that engine power output may be varied without air flow throttling. For maximum efficiency, the charge compression ratio must be less than sixty percent of the cylinder expansion ratio (commonly known as the engine compression ratio). Design should yield expanded combustion gases close to ambient pressure.

### DETAILED DESCRIPTION OF THE INVENTION

One embodiment of the present invention for operating a lean-burn homogeneous charge reciprocating internal combustion engine comprises a reciprocating engine utilizing conventional gasoline fuel or any suitable substitute. The operation of such an engine does not cause similar soot problems associated with the operation of diesel engines. Without throttling, charge inlet losses can approximate those of a diesel engine and even higher fuel economy may be achieved with full expansion of the combusted gases.

In an internal combustion engine/electric motor drive hybrid system, the engine need be operated only with on and off operation even with wide open throttle. Engine power may be varied by controlling engine speed, such as with a continuously variable transmission, and by varying the applied engine load as desired such as to charge the hybrid system battery. Use of a throttle may be used for engine start up but is limited to less than five percent of engine operation. Alternatively, engine power may be controlled by varying the amount of the lean fuel-air mixture charged; however, there will be a corresponding sacrifice in efficiency for additional power.

The method for operating the lean-burn homogeneous charge reciprocating internal combustion engine comprises providing an unthrottled fuel-air compression charge having a lean fuel-air ratio and passing the fuel-air compression charge to into the cylinders of the internal combustion engine and filling no more than sixty percent of each cylinder. The lean fuel-air ratio mixture defines a flammable adiabatic flame temperature when it is passed into the engine. Such mixture passing into the engine, and typically subsequently into a cylinder, defines a fuel-air compression charge in a cylinder. The charged fuel-air ratio may be controlled to maximize engine efficiency whereby the lean fuel-air ratio, at the initial fuel-air compression charge within the engine, is chosen for optimum efficiency. The compression charge is limited to no more than sixty or seventy percent of cylinder capacity, that is the compression ratio is less than sixty or seventy percent of the expansion ratio. Subsequently, the fuel-air compression charge is compressed within the cylinder.

In a preferred embodiment of the present invention, the engine compression/expansion ratio is typically at least fifteen or twenty such that the compression charge is compressed at least by a ratio of eight-to-one or nine-to-one, or even ten-to-one or higher. Higher compression ratios are feasible with premium grade fuels. The compressed charge is subsequently ignited for combustion within the internal combustion engine. Typically, a spark is provided to initiate ignition of the compressed charge. Many methods are known in the prior art for providing such a spark; most notably, a spark plug.

Spark timing just before, or slightly after, top dead center provides for starting combustion at a higher flame temperature. Hybrid operation comprising varying the applied engine load allows control of engine speed while providing for optimum combustion. Engine speed is limited by the time for combustion which is dependent upon the type of fuel used.

After combustion of the compressed fuel-air compression charge, the resulting exhaust is passed to a NOx removal system. Such systems, for example a NOx trap, are well known in the art. In addition, the emission of platinum oxides from conventional clean-up catalysts can be eliminated; the emission of hydrocarbons and carbon monoxide is greatly reduced with lean operation; and further reductions in emissions may be obtained by using an ultra low volatility non-platinum oxidation catalyst such as palladium, for example, to control carbon monoxide emissions in the exhaust.

Although the invention has been described in considerable detail with respect to the operation of an internal combustion engine/electric motor drive system whereby the internal combustion engine is operated unthrottled to maximize the efficiency of the overall system, it will be apparent that the invention is capable of numerous modifications and variations, apparent to those skilled in the art, without departing from the spirit and scope of the invention.

1. A method for operating a lean-burn homogeneous charge reciprocating internal combustion engine comprising:
a) providing an unthrottled fuel-air compression charge having a lean fuel-air ratio;
b) passing the fuel-air compression charge to fill no more than sixty percent of a cylinder within the internal combustion engine;
c) compressing the fuel-air compression charge within the cylinder;
d) igniting the compressed fuel-air compression charge for combustion; and
e) passing exhaust resulting from the combustion to a NOx removal system.

2. The method of claim 1 further comprising providing a non-platinum oxidation catalyst to control carbon monoxide emissions in the exhaust.

3. The method of claim 1 wherein the charged fuel-air ratio is controlled to maximize engine efficiency.

4. The method of claim 3 wherein power is varied by controlling the engine speed.

5. A method for operating an unthrottled, lean-burn homogeneous charge reciprocating internal combustion engine comprising:
a) supplying a lean fuel-air ratio mixture having a flammable adiabatic flame temperature;
b) compressing the lean fuel-air ratio mixture in the engine such that the compression ratio is less than seventy percent of the expansion ratio;
c) igniting the compressed lean fuel-air ratio mixture for combustion; and
d) passing exhaust resulting from the combustion to a NOx removal system.

6. The method of claim 5 wherein combustion is ignited at a point prior to top dead center.

7. The method of claim 5 wherein the fuel-air charge compression ratio is greater than nine to one.

8. The method of claim 6 wherein engine speed is controlled by varying the applied engine load.

9. The method of claim 6 wherein power is controlled by varying the amount of the lean fuel-air mixture charged.

10. The method of claim 6 further comprising use in an internal combustion engine/electric motor drive hybrid system.

11. The method of claim 10 wherein the step of compressing the lean fuel-air ratio mixture comprises compressing the lean fuel-air ratio mixture at least ten fold.

12. The method of claim 11 wherein the engine is operated in an on and off manner.
